(19) United States
(12) Patent Application Publication
(10) Pub. No.: US 2024/0057226 A1
(43) Pub. Date: Feb. 15, 2024

(54) COOKING APPLIANCE

(71) Applicant: LG ELECTRONICS INC., Seoul (KR)

(72) Inventors: Younghwan KWACK, Seoul (KR); Seongho SON, Seoul (KR); Seonho JEON, Seoul (KR); Chuhyoung CHO, Seoul (KR); Jongseong JI, Seoul (KR)

(73) Assignee: LG ELECTRONICS INC., Seoul (KR)

(21) Appl. No.: 18/231,828

(22) Filed: Aug. 9, 2023

(30) Foreign Application Priority Data
Aug. 10, 2022 (KR) 10-2022-0100032

(51) Int. Cl. H05B 6/06; H05B 6/12

(52) U.S. Cl. CPC H05B 6/065; H05B 6/1272; H05B 2213/05

(57) ABSTRACT

A cooking appliance includes a top plate portion configured to support an object to be heated; an intermediate heating body configured to transfer heat to the object; and a plurality of working coils configured to generate a magnetic field to heat at least a portion of the object to be heated and the intermediate heating body. Also, the intermediate heating body includes one or more heating areas corresponding to one or more working coils among the plurality of working coils.

### CROSS-REFERENCE TO RELATED APPLICATIONS

This application claims priority to Korean Patent Application No. 10-2022-0100032, filed in the Republic of Korea on Aug. 10, 2022, the entirety of which is incorporated herein by reference.

### BACKGROUND

### Technical Field

The present disclosure relates to a cooking appliance. More particularly, the present disclosure relates to the cooking appliance which is capable of heating all of a magnetic body and a nonmagnetic body.

### Discussion of the Related Art

Various types of cooking appliances are used to heat food at home or in the restaurant. According to the related art, a gas stove using gas as a fuel has been widely used. However, recently, devices for heating an object to be heated, for example, a cooking vessel such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking vessel) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops.

On the other hand, these cooking appliances have a significant limitation in terms of heating efficiency when compared to magnetic containers, as the heating efficiency for non-magnetic containers is very low. To address the issue of low heating efficiency for non-magnetic materials such as heat-resistant glass or ceramics, the cooktop includes an intermediate heating body through which eddy current is applied, enabling the heating of non-magnetic materials.

However, when an intermediate heating body is incorporated into cooking appliances, there is a slight decrease in heating efficiency when heating magnetic containers. This is because, when heating magnetic containers, some magnetic field indirectly heats the containers by interacting with the intermediate heating body before reaching the magnetic containers.

### SUMMARY OF THE DISCLOSURE

The present disclosure aims to provide an induction heating type cooktop that enhances the heating efficiency for both magnetic and non-magnetic materials.

The present disclosure aims to provide an induction heating type cooktop that minimizes the decrease in heating efficiency when heating magnetic containers by incorporating an intermediate heating body.

The present disclosure aims to provide a cooking appliance that adjusts the amount of heat generated in the intermediate heating body based on the type of an object to be heated.

The present disclosure aims to enhance the user-friendliness of cooking appliances incorporating an intermediate heating body.

The present disclosure aims to provide a cooking appliance that efficiently heats the object to be heated from any arbitrary position where the user places the object to be heated, without requiring a predetermined position for a heating zone.

A cooking appliance according to an embodiment of the present disclosure can include: a top plate portion on which an object to be heated is placed; an intermediate heating body heated to transfer heat to the object to be heated; and a plurality of working coils generating a magnetic field to heat at least a portion of the object to be heated and the intermediate heating body, in which the intermediate heating body is formed of heating areas corresponding to one or more working coils.

Each of the heating areas corresponds to one working coil.

Each of the heating areas corresponds to two working coils, and the outer diameter of the two working coils is larger than the inner diameter of each of the heating areas and smaller than the outer diameter of each of the heating areas.

An overlapping region, which is an intersection region between the heating areas, is formed on the intermediate heating body.

The cooking appliance further comprises at least one switch for determining whether or not current is blocked in the intersection region.

The switch is turned on or off according to the object to be heated.

The switch is turned off when the object to be heated is a magnetic body, and turned on when the object to be heated is a non-magnetic body.

The phase of the plurality of working coils is controlled differently depending on the type of object to be heated.

When the object to be heated is a magnetic body, the plurality of working coils are controlled in opposite phases.

The intermediate heating body is formed of a plurality of heating elements, and at least one of the plurality of heating elements has a shape having a closed loop larger than the outer diameter of one or more working coils, and at least another one has a shape having a closed loop smaller than the outer diameter of one or more working coils.

The cooking appliance further includes a switch for determining whether or not a closed loop is formed in each of the plurality of heating elements.

According to an embodiment of this disclosure, it is advantageous that both magnetic and non-magnetic materials can be heated using the working coil or the intermediate heating body, allowing for the heating of the object to be heated regardless of its material.

According to an embodiment of this disclosure, it is advantageous to maximize heating efficiency by determining the specific working coil to be activated, adjusting the phase of the working coil, and controlling the heat output by manipulating the closed loops formed in the intermediate heating body based on the material, size, and position of the object to be heated.

### BRIEF DESCRIPTION OF THE DRAWINGS

The above and other aspects, features and other advantages of the present disclosure will be more clearly understood from the following detailed description taken in conjunction with the accompanying drawings, which are briefly described below.

FIG. 1 is a perspective view illustrating a cooking appliance according to an embodiment of the present disclosure.

FIG. 2 is a circuit diagram of a cooking appliance according to an embodiment of the present disclosure.

FIG. 3 is a cross-sectional view illustrating a cooking appliance and an object to be heated according to an embodiment of the present disclosure.

FIG. 4 is a cross-sectional view illustrating a cooking appliance and an object to be heated according to another embodiment of the present disclosure.

FIG. 5 is a plan view illustrating a WC and an intermediate heating body (IM) according to a first embodiment of the present disclosure.

FIG. 6 is a plan view illustrating a WC and an IM according to a second embodiment of the present disclosure.

FIG. 7 is a plan view illustrating a WC and an IM according to a third embodiment of the present disclosure.

FIG. 8 is an exemplary diagram illustrating heat generation in a WC and an IM when only the S1 and S2 are turned on in FIG. 7 according to an embodiment of the present disclosure.

FIG. 9 is a plan view illustrating a WC and an IM according to a fourth embodiment of the present disclosure.

FIG. 10 is a plan view illustrating a WC and an IM according to a fifth embodiment of the present disclosure.

FIG. 11 is a plan view illustrating a WC and an IM according to a sixth embodiment of the present disclosure.

FIG. 12 is a plan view illustrating a WC and an IM according to a seventh embodiment of the present disclosure.

FIG. 13 is a plan view illustrating a WC and an IM according to an eighth embodiment of the present disclosure.

FIG. 14 is an illustrative diagram showing the appearance of an intermediate heating element formed by multiple heating elements according to an exemplary embodiment of the present disclosure.

FIG. 15 is an exemplary view illustrating arrangement of an IM and a switch formed of a plurality of heating members according to an embodiment of the present disclosure.

FIG. 16 is an exemplary view showing a state in which an IM is formed in a plurality of concentric circle shapes according to an embodiment of the present disclosure.

FIG. 17 is an exemplary diagram illustrating the arrangement of IMs and switches formed in a plurality of concentric circle shapes according to an embodiment of the present disclosure.

FIG. 18 is an exemplary view showing an IM formed in a shape having an elliptical closed loop and a circular closed loop according to an embodiment of the present disclosure.

FIG. 19 is an exemplary view illustrating arrangement of Ims and switches having closed loops of various shapes according to an embodiment of the present disclosure.

FIG. 20 is a control block diagram for explaining a method of operating a cooking appliance according to an embodiment of the present disclosure.

### DETAILED DESCRIPTION OF THE EMBODIMENTS

Hereinafter, preferred embodiments according to the present disclosure will be described in detail with reference to the accompanying drawings. In the drawings, the same reference numerals are used to indicate the same or similar components.

The suffixes “module” and “portion” for components used in the following description are given or used together in consideration of ease of writing the specification, and do not have meanings or roles that are distinct from each other by themselves.

In the following description, “connection” between components includes not only direct connection of components, but also indirect connection through at least one other component, unless otherwise specified.

Hereinafter, a cooking appliance and an operating method thereof according to an embodiment of the present disclosure will be described. Hereinafter, the cooking appliance can be an induction heating type cooktop. The following embodiments can be partially or entirely bonded to or combined with each other and can be linked and operated in technically various ways. The embodiments can be carried out independently of or in association with each other.

Hereinafter, a cooking appliance according to an embodiment of the present disclosure will be described.

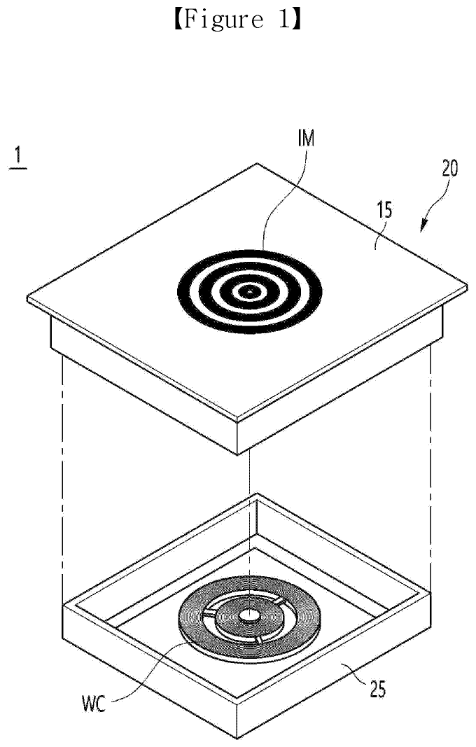

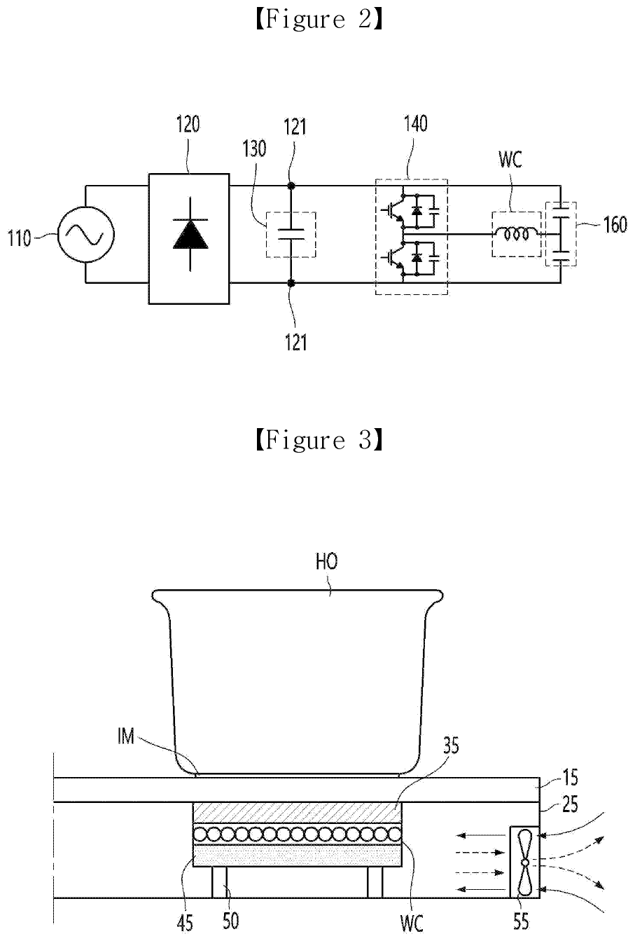

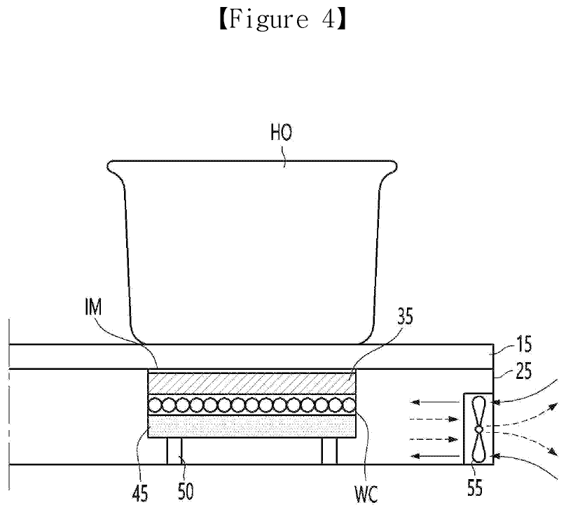

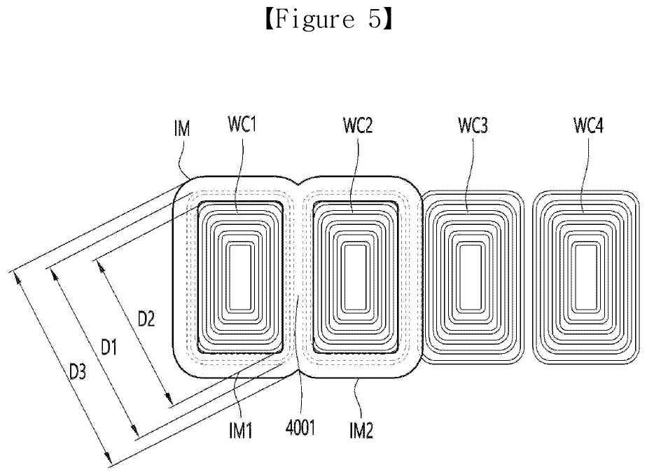

FIG. 1 is a perspective view illustrating a cooking appliance according to an embodiment of the present disclosure, FIG. 2 is a circuit diagram of a cooking appliance according to an embodiment of the present disclosure, FIG. 3 is a cross-sectional view illustrating a cooking appliance and an object to be heated according to an embodiment of the present disclosure, and FIG. 4 is a cross-sectional view illustrating a cooking appliance and an object to be heated according to another embodiment of the present disclosure.

First, referring to FIG. 1, a cooking appliance 1 according to an embodiment of the present disclosure includes a case 25, a cover plate 20, a working coil (WC), and an intermediate heating body (IM).

The WC can be installed in the case 25.

For reference, in the case 25, various devices related to driving of the working coil (for example, a power supply that provides alternating current (AC) power, a rectifier that rectifies the AC power of the power supply into direct current (DC) power, an inverter that converts the DC power rectified by the rectifier into resonance current through a switching operation to provides the resonance current to the WC, a control module that controls operations of various devices within the cooking appliance 1, a relay or semi-conductor switch that turns on or off the WC, etc.) in addition the working coils (e.g., WC1 and WC2) can be installed in the case 25.

The cover plate 20 can be coupled to an upper end of the case 25 and be provided with an upper plate 15 on which an object to be heated (HO) is disposed on a top surface thereof.

Specifically, the cover plate 20 can include the upper plate 15 for disposing an HO, such as a cooking vessel. thereon. That is, an HO can be disposed on the upper plate 15.

Here, the upper plate 15 can be made of, for example, a glass material (e.g., ceramics glass).

In addition, the upper plate 15 can be provided with an input interface that receives an input from a user to transmit the input to a control module for an input interface. Of course, the input interface can be provided at a position other than the upper plate 15.

For reference, the input interface can be a module for inputting a desired heating intensity or driving time of the cooking appliance 1 and can be variously implemented with a physical button or a touch panel. Also, the input interface can include, for example, a power button, a lock button, a power level adjustment button (+, −), a timer adjustment button (+, −), a charging mode button, and the like. In addition, the input interface can transmit the input received from the user to the control module for the input interface, and the control module for the input interface can transmit the input to the aforementioned control module (e.g., the control module for the inverter). In addition, the aforementioned control module can control the operations of various devices (e.g., the WCs) based on the input (e.g., a user input) provided from the control module for the input interface.

Whether the WC is driven and the heating intensity (e.g., thermal power) can be visually displayed on the upper plate 15 in a shape of a crater. The shape of the crater can be indicated by an indicator constituted by a plurality of light emitting devices (e.g., LEDs) provided in the case 25.

The WC can be installed inside the case 25 to heat the HO.

Specifically, the WC can be driven by the aforementioned control module, and when the HO is disposed on the upper plate 15, the WC can be driven by the control module.

In addition, the WC can directly heat an HO (e.g., a magnetic body) having magnetism and can indirectly heat an object to be used (e.g., a non-magnetic body) through an IM that will be described later.

In addition, the WC can heat the HO in an induction heating manner and can be provided to overlap the IM in a longitudinal direction (e.g., a vertical direction or an upward and downward direction).

For reference, although the structure in which one WC is installed in the case 25 is illustrated in FIG. 1, the embodiment is not limited thereto. That is, one or more WCs can be installed in the case 25. The IM can be installed to correspond to the WC. The number of TMs and the number of WCs can be the same.

The IM can be installed on the upper plate 15. The IM can be applied on the upper plate 15 to heat the non-magnetic body among HOs. The IM can be inductively heated by WC.

The IM can be disposed on a top surface or a bottom surface of the upper plate 15. For example, as illustrated in FIG. 2, the IM can be installed on the top surface of the upper plate 15, or as illustrated in FIG. 3, the IM can be installed on the bottom surface of the upper plate 15.

The IM can be provided to overlap WC in the longitudinal direction (e.g., the vertical direction or the upward and downward direction). Thus, the heating of the HO can be possible regardless of the arrangement positions and types of HOs.

Also, the IM can have at least one of magnetic and non-magnetic properties (e.g., a magnetic property, a non-magnetic property, or both the magnetic and non-magnetic properties).

In addition, IM can be made of, for example, a conductive material (e.g., aluminum), and as illustrated in the drawings, a plurality of rings having different diameters can be installed on the upper plate 15 in a repeated shape, but is not limited thereto. That is, IM can be made of a material other than a conductive material. Also, the IM can be provided in a shape other than the shape in which the plurality of rings having different diameters are repeated.

For reference, although one IM is illustrated in FIGS. 3 and 4, the embodiment is not limited thereto. That is, a plurality of thin films can be installed, but for convenience of description, one IM can be installed as an example.

FIG. 2 is a circuit diagram of a cooking appliance according to an embodiment of the present disclosure.

Referring to FIG. 2, the cooking appliance can include at least some or all of a power supply 110, a rectifier 120, a direct current (DC) link capacitor 130, an inverter 140, a WC, and a resonance capacitor 160.

The power supply 110 can receive external power. The power that the power supply 110 receives from the outside can be Alternative Current (AC) power.

The power supply 110 can supply AC voltage to the rectifier 120.

The rectifier 120 is an electrical device for converting AC into DC. The rectifier 120 converts the AC voltage supplied through the power supply 110 into a DC voltage. The rectifier 120 can supply the converted voltage to DC both terminals 121.

An output terminal of the rectifier 120 can be connected to DC both terminals 121. The DC both terminals 121 output through the rectifier 120 can be referred to as a DC link. The voltage measured across the DC both terminals 121 is referred to as the DC link voltage.

The DC link capacitor 130 serves as a buffer between the power supply 110 and the inverter 140. Specifically, the DC link capacitor 130 is used to maintain the DC link voltage converted through the rectifier 120 and supply the DC link voltage to the inverter 140.

The inverter 140 serves to switch a voltage applied to the WC so that a high-frequency current flows through the WC. The inverter 140 can apply current to the WC. The inverter 140 can include a relay, a semiconductor switch, or the like that turns on or off the WC. For example, the inverter 140 can include a semiconductor switch, and the semiconductor switch can be an Insulated Gate Bipolar Transistor (IGBT) or a Wide Band Gab (WBG) element, but this is only exemplary and is not limited thereto. Meanwhile, the WBG element can be SiC (Silicon Carbide), GaN (Gallium Nitride), or the like. The inverter 140 causes a high-frequency current to flow through the WC by driving the semi-conductor switch, and thus a high-frequency magnetic field is formed in the WC.

The WC can include at least one WC generating a magnetic field for heating the HO. Current may or may not flow through the WC depending on whether the switching element is driven. When a current flows through the WC, a magnetic field is generated. The WC can heat the cooking appliance by generating a magnetic field as current flows.

One side of the WC is connected to the connection point of the switching element of the inverter 140, and the other side thereof is connected to the resonant capacitor 160.

The driving of the switching element is performed by a driver, and is controlled at a switching time output from the driver to apply a high-frequency voltage to the WC while the switching elements alternately operate with each other. In addition, since the on/off time of the switching element applied from the driver is controlled in a gradually compensated manner, the voltage supplied to the WC changes from a low voltage to a high voltage.

The resonance capacitor 160 can resonate with the WC.

The resonance capacitor 160 can be a component for serving as a shock absorber. The resonance capacitor 160 affects the energy loss during the turn-off time by adjusting the saturation voltage rise rate during the turn-off of the switching element.

Next, referring to FIGS. 3 and 4, the cooking appliance 1 according to an embodiment of the present disclosure can further include at least some or all of an insulating material 35, a shielding plate 45, a support member 50, and a cooling fan 55.

The insulating material 35 can be provided between the upper plate 15 and the WC.

Specifically, the insulating material 35 can be mounted under the upper plate 15, and the WC can be disposed below the insulating material 35.

The insulating material 35 can prevent heat generated while the IM or the HO to be heated by the driving of the WC from being transmitted to the WC.

That is, when the IM or the HO is heated by electromagnetic induction of the WC, the heat of the IM or the HO can be transferred to the upper plate 15, and then, the heat of the upper plate 15 can be transferred to the WC again to damage the WC.

The insulating material 35 can block the heat transferred to the WC as described above to prevent the WC from being damaged by the heat, and furthermore, prevent heating performance of the WC from being deteriorated.

For reference, although it is not an essential component, a spacer can be installed between the WC and the insulating material 35.

Specifically, the spacer can be inserted between the WC and the insulating material 35 so that the WC and the insulating material 35 are not in directly contact with each other. Thus, the spacer can prevent the heat generated while the IM or the HO by the driving of the WC from being transmitted to the WC through the insulating material 35.

That is, since the spacer partially shares the role of the insulating material 35, a thickness of the insulating material 35 can be minimized, and thus, an interval between the HO and the WC can be minimized.

In addition, the spacer can be provided in plurality, and the plurality of spacers can be disposed to be spaced apart from each other between the WC and the insulating material 35. Thus, air suctioned into the case 25 by a cooling fan 55 to be described later can be guided to the WC by the spacers.

That is, the spacers can guide the air introduced into the case 25 by the cooling fan 55 to be properly transferred to the WC, thereby improving cooling efficiency of the WC.

The shielding plate 45 can be mounted under the WC to block magnetic fields generated downward when the WC is driven.

Specifically, the shielding plate 45 can block the magnetic fields generated downward when the WC is driven and can be supported upward by the support member 50.

The support member 50 can be installed between a bottom surface of the shielding plate 45 and the lower plate of the case 25 to support the shielding plate 45 upward.

Specifically, the support member 50 can support the shielding plate 45 upward to indirectly support the insulating material 35 and the WC upward, and thus, the insulating material 35 can be in close contact with the upper plate 15.

As a result, the interval between the WC and the HO can be constantly maintained.

For reference, the support member 50 can include, for example, an elastic body (e.g., a spring) for supporting the shielding plate 45 upward, but is not limited thereto.

In addition, since the support member 50 is not an essential component, the support member 50 can be omitted from the cooking appliance 1.

The cooling fan 55 can be installed inside the case 25 to cool the WC.

Specifically, the cooling fan 55 can be controlled to be driven by the above-described control module and can be installed on a sidewall of the case 25. Of course, the cooling fan 55 can be installed at a position other than the sidewall of the case 25, but in the present disclosure, for convenience of explanation, the structure in which the cooling fan 55 is installed on the sidewall of the case 25 will be described as an example.

In addition, as illustrated in FIGS. 3 and 4, the cooling fan 55 can suction air from the outside of the case 25 to deliver the air to the WC or can suction air (particularly, heated air) inside the case 25 to discharge the air to the outside of the case 25.

As a result, efficient cooling of the components (in particular, the WC) inside the case 25 is possible.

Also, as described above, the air outside the case 25 delivered to the WC by the cooling fan 55 can be guided to the WC by the spacers. Thus, the direct and efficient cooling of the WC is possible to improve durability of the WC (e.g., improvement in durability due to prevention of thermal damage).

The IM can be a material having a resistance value that is capable of being heated by the WC.

A thickness of the IM can be inversely proportional to the resistance value (e.g., a surface resistance value) of the IM. That is, as the thickness of the IM decreases, the resistance value (e.g., surface resistance value) of the IM increases. Thus, characteristics of the IM can be changed to a load that can be heated.

For reference, the IM according to the embodiment of FIG. 2 through FIG. 3 can have a thickness of, for example, about 0.1 μm to about 1,000 but is not limited thereto.

The IM having such characteristics can be present to heat the non-magnetic body, and thus, impedance characteristics between the IM and the HO can be changed according to whether the HO disposed on the upper plate 15 is a magnetic body or non-magnetic body.

The situation in which the HO is the magnetic body will be described as follows.

When the magnetic HO is disposed on the upper plate 15, and the working coil WC is driven, a resistance component (R1) and an inductor component (L1) of the HO, which has the magnetism as illustrated in FIG. 4) can form an equivalent circuit with a resistance component (R2) and an inductor component (L2) of the IM. In this situation, the impedance (e.g., impedance measured by R1 and L1) of the HO, which has the magnetism, in the equivalent circuit can be less than that of the IM (e.g., the impedance measured by R2 and L2). Thus, when the equivalent circuit as described above is formed, magnitude of the eddy current Ti applied to the magnetic HO can be greater than that of the eddy current 12 applied to the IM. Thus, most of the eddy current generated by the WC can be applied to the HO to be heated, and thus, the HO can be heated. That is, when the HO is the magnetic body, the above-described equivalent circuit can be formed, and thus, most of the eddy current can be applied to the HO to be heated. As a result, the WC can directly heat the HO.

Next, the situation in which the HO is the non-magnetic body will be described as follows.

When the HO, which does not have the magnetism, is disposed on the upper plate 15, and the WC is driven, there is no impedance in the non-magnetic HO, and the IM can have an impedance. That is, the resistance component R and the inductor component L can exist only in the IM. Therefore, when the non-magnetic HO to be heated is disposed on the upper plate 15 and the WC is driven, as illustrated in FIG. 5, the resistance component R and the inductor component L of the IM can form an equivalent circuit. Thus, eddy current I can be applied only to the IM, and eddy current may not be applied to the HO, which does not have magnetism. More specifically, the eddy current I generated by the WC can be applied only to the IM, and thus, the IM can be heated. That is, when the HO is the non-magnetic body, as described above, the eddy current I can be applied to the IM to heat the IM, and the HO, which does not have magnetism, can be indirectly heated by the IM heated by the WC. In this situation, the IM can be a main heating source.

In summary, the HO can be directly or indirectly heated by a single heat source, which is called the WC, regardless of whether the HO is the magnetic body or the non-magnetic body. That is, when the HO is the magnetic body, the WC can directly heat the HO, and when the HO is the non-magnetic body, the IM heated by the WC can indirectly heat the HO.

Meanwhile, when the HO is a magnetic material, the heating efficiency is highest when all of the magnetic field generated from the WC is combined with the HO, but as a portion of the magnetic field is combined with the IM, there is a problem in that the heating efficiency is somewhat lowered. Therefore, when the HO is a magnetic material, the binding force between the magnetic field generated from the WC and the IM is adjusted weakly, and when the HO is a non-magnetic material, there is a need for a method that can strongly control the binding force between the magnetic field generated from the WC and the IM.

Therefore, a cooktop is disclosed that includes a plurality of WC and a plurality of IMs. In the cooktop, at least some of the WCs can operate according to HO and the amount of heat generated by IM can be adjusted.

According to one embodiment of the present disclosure, the cooking appliance comprises an IM that is heated to transfer heat to the HO and a plurality of WCs that generate a magnetic field to heat at least a portion of the HO and IM. The IM can be formed in a shape with a closed loop larger than the outer diameter of at least one of WCs. In other words, the IM can be arranged to overlap vertically with the outer circumference of at least one WC among the multiple WCs.

Hereafter, the arrangement, structure, and shape of the WCs and the IM will be described. Each of the WCs can be formed in a shape where the coil is wound with multiple turns. The outer diameter of a single WC can refer to the longest diameter among the diameters of the coils wound on the outermost part of that specific WC. The outer diameter of two WCs can refer to the longest diameter among the diameters of the outermost coils of both WCs when considered together.

The outer diameter of each heating area formed on the IM which will be described later, can refer to the longest diameter among the diameters of the outer circumference of the respective heating area. The inner diameter of each heating area can refer to the longest diameter among the diameters of the inner circumference of the respective heating area.

FIG. 5 is a plan view illustrating a WC and an IM according to a first embodiment of the present disclosure.

The cooking appliance according to the first embodiment of the present disclosure includes multiple WCs, WC1 to WC4, and an IM. The IM can be formed in a shape with a closed loop larger than the outer diameter D1 of each of WC1 and WC2, which are included in the IM.

Specifically, the IM can be composed of a first heating area (IM1) where a closed loop larger than the outer diameter D1 of WC1 is formed, and a second heating area (IM2) where a closed loop larger than the outer diameter D1 of WC2 is formed. The IM1 and IM2 can share an intersecting area 4001. In other words, both the IM1 and IM2 can encompass the intersecting area 4001.

That is, the intersecting area, which can be an overlapping area between a plurality of heating areas, can be formed in the IM.

The inner diameter D2 of IM1 can be smaller than the outer diameter D1 of WC1 and the outer diameter D3 of IM1 can be greater the outer diameter D1 of WC1.

Similarly, an inner diameter D2 of IM2 can be smaller than an outer diameter D1 of WC2 and an outer diameter D3 of IM2 can be larger than the outer diameter D1 of WC2.

Accordingly, when HO is placed at a position corresponding to WC1 and WC2, WC1 and WC2 operate to generate a magnetic field. The magnetic field can pass through IM1 and IM2, respectively, so that IM1 and IM2 can generate heat.

On the other hand, in FIG. 5, even though it is described that the IM is disposed at the position corresponding to WC1 and WC2 among the plurality of WCs, WC1 to WC4, the position of IM is not limited. That is, the IM can be disposed at a position corresponding to WC2 and WC3 or WC3 and WC4 among the plurality of WCs, WC1 to WC4.

In addition, FIG. 5 shows that IM is disposed only at positions corresponding to some WCs (e.g., WC1 and WC2) among the plurality of WCs, WC1 to WC4. The IM, however, can be disposed at a position corresponding to the entirety of the WCs, WC1 to WC4.

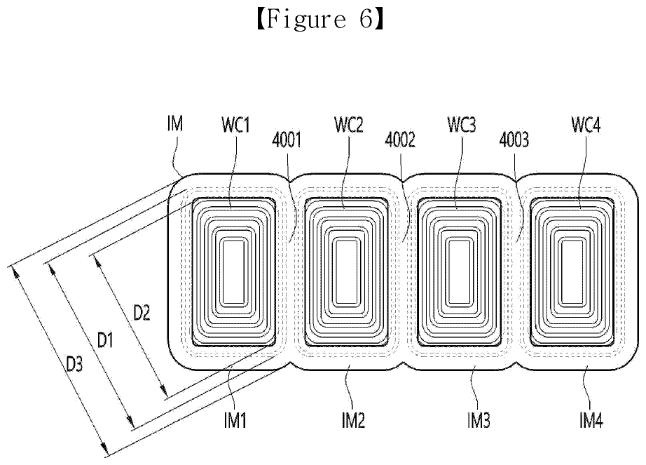

FIG. 6 is a plan view illustrating a WC and an IM according to a second embodiment of the present disclosure.

The cooking appliance according to the second embodiment of the present disclosure includes a plurality of WCs, WC1 to WC4, and an IM. The IM can be formed in a shape having a closed loop larger than the outer diameter of each of the WCs, WC1 to WC4.

Specifically, the IM can include first to fourth heating areas, IM1 to IM4. The IM1 can be a region in which a closed loop larger than the outer diameter D1 of the WC1 is formed. The IM2 can be a region in which a closed loop larger than the outer diameter D1 of WC2 is formed. The IM3 can be a region in which a closed loop larger than the outer diameter D1 of WC3 is formed. The IM4 can be a closed loop larger than the outer diameter D1 of WC4.

The IM1 and IM2 can share a first intersecting area 4001. The IM2 and IM3 can share a second intersecting area 4002. The IM3 and IM4 can share the third intersection region 4003. That is, both IM1 and IM2 can include the first intersecting area 4001. Both IM2 and IM3 can include the second intersecting area 4002. Both IM3 and IM4 can include the third intersecting area 4003.

The IM can be composed of a plurality of heating areas, IM1 to IM4. An outer diameter D1 of each of the plurality of WCs, WC1 to WC4, can be larger than an inner diameter D2 of each of the plurality of heating areas, IM1 to IM4, and can be smaller than an outer diameter D3 of each of the plurality of heating areas, IM1 to IM4.

An inner diameter D2 of IM1 can be smaller than the outer diameter D1 of WC1. An outer diameter D3 of IM1 can be larger than the outer diameter D1 of WC1.

Similarly, an inner diameter D2 of IM2 can be smaller than the outer diameter D1 of WC2. An outer diameter D3 of IM2 can be larger than the outer diameter D1 of WC2. An inner diameter D2 of IM3 can be smaller than the outer diameter D1 of WC3. An outer diameter D3 of IM3 can be larger than the outer diameter D1 of WC3. An inner diameter D2 of IM4 can be smaller than the outer diameter D1 of WC4. An outer diameter D3 of IM4 can be larger than the outer diameter D1 of WC4.

Accordingly, at least one of the first to fourth WCs, WC1 to WC4, can operate according to the position and size of the HO. Similarly, at least some of the first to fourth heating areas, IM1 to IM4, can generate heat according to the position and size of HO. For example, when HO is placed at a position corresponding to WC2 and WC3, WC2 and WC3 can operate to generate a magnetic field. Such the magnetic field can pass through IM2 and IM3, respectively, so that IM2 and IM3 can generate heat. However, this is just an example, and single working coil or two or more WCs can operate according to the size of HO. The WCs operating can vary depending on the position of HO.

On the other hand, in the above-described embodiments, when HO, a magnetic material, is placed, there can be a problem of lowering heating efficiency due to some magnetic field coupling to IM instead of HO. That is, when heating HO, the magnetic material, heating efficiency can be increased by minimizing heat generation in IM. Accordingly, additional components can be required for containment the heat generation in IM can be suppressed during heating of HO, the magnetic material. For example, the additional component for suppressing heat generation in IM can be a switch.

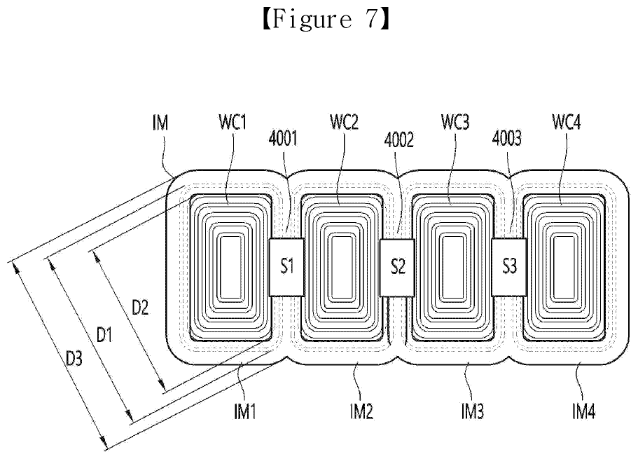

FIG. 7 is a plan view illustrating a WC and an IM according to a third embodiment of the present disclosure.

The cooking appliance according to the third embodiment of the present disclosure can include a plurality of WCs, WC1 to WC4. The cooking appliance can include a shape of an IM and switches, S1 to S3, having a closed loop larger than each outer diameter D1 of WCs, WC1 to WC4.

Similar to the explanation in FIG. 6, IM can be composed of first to fourth heating areas, IM1 to IM4. The IM1 can be an area where a closed loop larger than the outer diameter D1 of WC1 is formed. The IM2 can be an area where a closed loop larger than the outer diameter D1 of WC2 is formed. The IM3 can be an area in which a closed loop larger than the outer diameter D1 of WC3 is formed. The IM4 can be an area where a closed loop larger than the outer diameter D1 of WC4 is formed.

The IM1 and IM2 can share a first intersecting area 4001. The IM2 and IM3 can share a second intersecting area 4002. The IM3 and IM4 can share the third intersecting area 4003. That is, both IM1 and IM2 include the first intersecting area 4001, and both IM2 and IM3 have the second intersecting area 4002, and both IM3 and IM4 can include the third intersecting area 4003.

The IM1 has an inner diameter D2 smaller than the outer diameter D1 of WC1 and an outer diameter D3 larger than the outer diameter D1 of WC1.

Similarly, IM2 has an inner diameter D2 smaller than the outer diameter D1 of WC2, and an outer diameter D3 equal to the outer diameter D1 of WC2. The IM3 can have an inner diameter D2 smaller than the outer diameter D1 of WC3 and an outer diameter D3 larger than the outer diameter D1 of WC3. The IM4 can have an inner diameter D2 smaller than the outer diameter D1 of WC4 and an outer diameter D3 larger than the outer diameter D1 of WC4.

Switches, S1 to S3, can be provided in each of the first to third intersecting areas, 4001 through 4003. The switches, S1 to S3, can determine whether current is cut off in the intersecting areas, 4001 through 4003.

The S1 can be disposed in the first intersecting area 4001 and block a current in the first intersecting area 4001. The S1 can be turned on or off, and when S1 is turned on, current flows in the first intersecting area 4001, and when S1 is turned off, the first intersecting area 4001 may not flow.

The S2 can be disposed in the second intersecting area 4002 and block a current in the second intersecting area 4002. The S2 can be turned on or off. When S2 is turned on, current flows in the second intersecting area 4002, and when S2 is turned off, the second intersecting area 4002 may not flow.

The S3 can be disposed in the third intersecting area 4003 and block a current in the third intersecting area 4003. The S3 can be turned on or off. When S3 is turned on, current flows in the third intersecting area 4003, and when S3 is turned off, the third intersecting area 4003 may not flow.

That is, the area of the closed loop formed in IM can be changed according to the on or off of each of the first to third switches, S1 to S3, and accordingly, the IM (The calorific value in IM) can be adjusted.

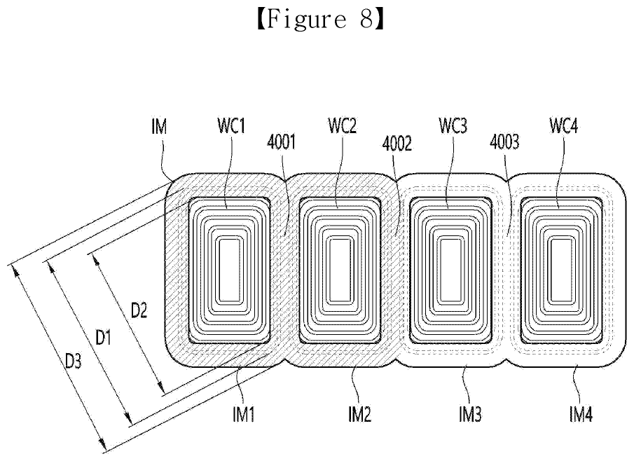

Referring to FIG. 8, the amount of heat generated in IM can be adjusted according to the on/off of each of the first to third switches, S1 to S3, will be described.

FIG. 8 is an exemplary diagram illustrating heat generation in a WC and an IM when only S1 and S2 are turned on in FIG. 7.

The example of FIG. 8 is a situation where the cooking appliance heats a non-magnetic HO placed at a position corresponding to WC1 and WC2. Only S1 and S2 can be turned on, and S3 can be turned off. Accordingly, since the current is not conducted in the third intersecting area 4003, IM1 and IM2 including the 4001 and 4002 can be intensively heated.

On the other hand, the current in IM4 may not entirely blocked, but only WC1 and WC2 can operate efficiently. The coupling force between the magnetic field generated in IM3 and IM4 can be weak.

Accordingly, IM1 and IM2 indicated by hatched lines can generate concentrated heat so that HO can be heated.

In addition, when heating HO, which is a non-magnetic material, the frequency of operating WCs can be controlled to be the same frequency. In the example of FIG. 8, the cooking appliance can control WC1 and WC2 at the same frequency.

On the other hand, when the cooking appliance heats HO, which is a magnetic material, the amount of heat generated in IM should be suppressed. Accordingly, when the cooking appliance heats HO, which is a magnetic material, all of S1 to S3 can be turned off. Accordingly, since current flows only in areas other than the first to third intersecting areas, 4001 through 4003, the magnetic field coupling force of IM can be weakened. According to the embodiment, when the cooking appliance heats HO, which is a magnetic material, the switch corresponding to the position where HO is placed among S1 to S3.

In addition, when the cooking appliance heats HO, which is a magnetic material, the phases of operating WCs can be reversed. For example, the cooking appliance turns off at least S1 when HO, which is a magnetic material, is placed at a position corresponding to WC1 and WC2. Phases of WC1 and WC2 can be reversely controlled. That is, the direction of the current flowing through WC1 and the direction of the current flowing through WC2 can be opposite. In this situation, since the magnetic field of the region facing the current is offset, the magnetic field is concentrated in the inner region of the inner circumference 2111 of IM1 and the inner region of the inner circumference 2112 of IM2. Accordingly, the magnetic field can be concentrated on HO.

According to another embodiment of the present disclosure, the cooking appliance can further include a switch disposed in an area other than the intersecting areas, 4001 through 4003, of IM.

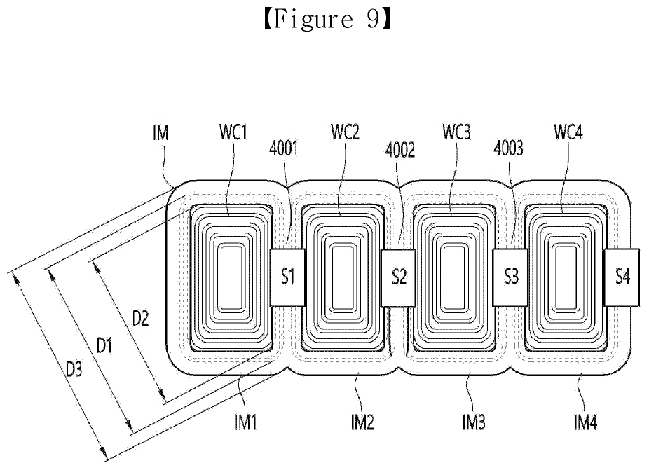

FIG. 9 is a plan view illustrating a WC and an IM according to a fourth embodiment of the present disclosure.

The cooking appliance according to the fourth embodiment of the present disclosure includes a plurality of WCs, WC1 to WC4, the WC1 to WC4, can include an IM and switches, S1 to S4, having a shape having a closed loop larger than each outer diameter D1.

Since it is similar to that described in FIG. 7 except for the S4, duplicate descriptions will be omitted.

Each of the S1 to S3 can be positioned at each of the first to third intersecting areas, 4001 through 4003. The S4 can be disposed in IM4 excluding the third intersecting area 4003.

When there is no S4, a closed loop including IM1 and IM4 can be formed. The cooking appliance according to the fourth embodiment of the present disclosure further includes a fourth switch, S4, and a current in IM4 can be cut off by turning on or off S4.

For example, when S1 to S4 are all turned off, IM has WCs, WC1 to WC4, is not formed, and thus the magnetic field coupling force can be very weak.

Meanwhile, in FIGS. 5 to 9, it has been described that one heating area is formed corresponding to one WC of IM, but this is an example.

In IM, heating areas corresponding to two or more WCs can be formed.

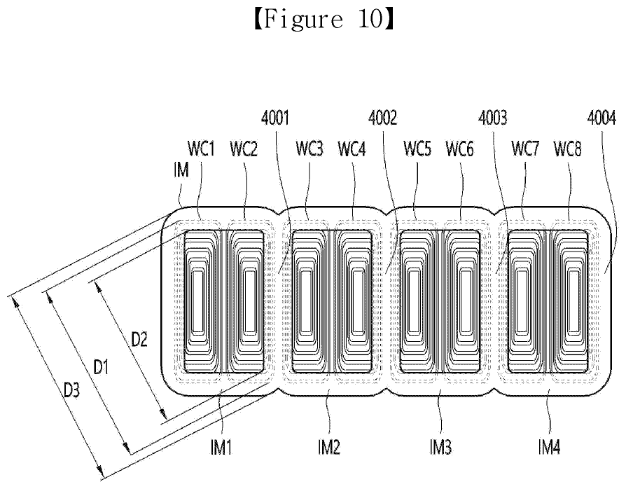

FIG. 10 is a plan view illustrating a WC and an IM according to a fifth embodiment of the present disclosure.

The cooking appliance according to the fifth embodiment of the present disclosure includes a plurality of WCs, WC1 to WC8, and an IM. The IM can be formed in a shape having a closed loop larger than the outer diameter of the sum of two WCs among the plurality of WCs.

Specifically, IM can include IM1 to IM4. The IM1 can include an area where a closed loop larger than the outer diameter D1 of the sum of WC1 and WC2 is formed. The IM2 can include an area where a closed loop larger than the outer diameter D1 of the sum of WC3 and WC4 is formed. The IM3 can include an area where a closed loop larger than the outer diameter D1 of the sum of WC5 and WC6 is formed. The IM4 can include an area where a closed loop larger than the outer diameter D1 of the sum of WC7 and WC8 is formed.

The outer diameter D1 of WC1 and WC2 is the longest diameter among the outermost diameters of WC1 and WC2, that is, WC1 and WC2. It means the outer diameter of the sum of WC1 and WC2, and the outer diameter D1 of WC3 and WC4 is the total of WC3 and WC4. It means the outer diameter of the longest diameter among the diameters of the outermost coils, that is, the sum of WC3 and WC4, and the outer diameter D1 of WC5 and WC6 means the longest diameter among the diameters of the outermost coils of WC5 and WC6, that is, the outer diameter of the sum of the WC5 and WC6, and the outer diameter D1 of WC7 and WC8 is the longest diameter, which means the outer diameter of the sum of WC7 and WC8, among diameters of the outermost coils of WC7 and WC8.

The IM1 and IM2 can share a first intersecting area 4001, and IM2 and IM3 can share a second intersecting area 4002. The IM3 and IM4 can share the third intersecting area 4003. That is, both IM1 and IM2 can include the first intersecting area 4001, and both IM2 and IM3 can include the second intersecting area 4002, and both IM3 and IM4 can include the third intersecting area 4003.

The IM is composed of a plurality of heating areas, IM1 to IM4, corresponding to the sum of two adjacently positioned WCs, and the outer diameter D1 of the two WCs can be larger than the inner diameter D2 of each of the plurality of heating areas and smaller than the outer diameter D3 of each of the plurality of heating areas.

The IM1 has an inner diameter D2 smaller than the outer diameter D1 of WC1 and WC2, and an outer diameter D3 of WC1 and WC2 can be larger than the outer diameter D2.

Similarly, IM2 has an inner diameter D2 smaller than the outer diameter D1 of WC3 and WC4, and an outer diameter D3 of WC3 and WC4 can be larger than the outer diameter D1. The IM3 has an inner diameter D2 smaller than the outer diameter D1 of WC5 and WC6, and an outer diameter D3 of WC5 and WC6 can be larger than the outer diameter D1. The IM4 has an inner diameter D2 smaller than the outer diameter D1 of WC7 and WC8, and an outer diameter D3 of WC7 and WC8 can be larger than the outer diameter D1.

Accordingly, at least one of the first to eighth WCs, WC1 to WC8, according to the position and size of HO operation, and similarly, at least some of IM1 to IM4 can generate heat according to the position and size of HO. For example, when HO is placed at a position corresponding to IM2, WC3 and WC4 can operate to generate a magnetic field, and this magnetic field heat can be generated in IM2 by passing through IM2. However, this is just an example, and single WC or two or more WCs can operate according to the size of HO, and WCs operating can vary depending on the position of HO.

On the other hand, in the above-described embodiments, when HO of the magnetic material is placed, there is a problem of deterioration in heating efficiency due to some magnetic field being coupled to IM instead of HO. That is, when heating HO, a magnetic material, heating efficiency can be increased by minimizing heat generation in IM, and accordingly, heat generation in IM can be reduced during heating of the magnetic material. Additional components can be required for containment. For example, an additional component for suppressing heat generation in IM can be a switch.

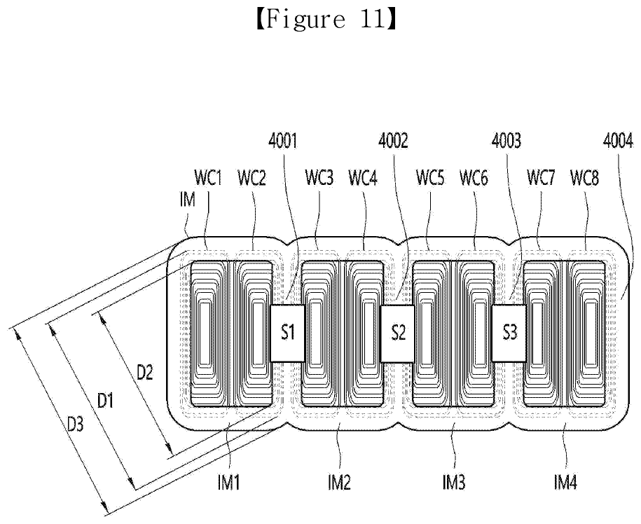

FIG. 11 is a plan view illustrating a WC and an IM according to a sixth embodiment of the present disclosure.

The cooking appliance according to the sixth embodiment of the present disclosure includes a plurality of WCs, WC1 to WC8, outer diameters D1 of two WCs can include an IM having a shape having a larger closed loop and switches, S1 to S3.

Similar to that described in FIG. 11, IM can include first to fourth heating areas, IM1 to IM4. The IM1 can be a region in which a closed loop larger than the outer diameter D1 of the sum of WC1 and WC2 is formed. The IM2 can be a region in which a closed loop larger than the outer diameter D1 of the sum of WC3 and WC4 is formed. The IM3 can be a region in which a closed loop larger than the outer diameter D1 of the sum of WC5 and WC6 is formed. The IM4 can be a region in which a closed loop larger than the outer diameter D1 of the sum of WC7 and WC8 is formed.

The IM1 and IM2 can share a first intersecting area 4001. The IM2 and IM3 can share a second intersecting area 4002. The IM3 and IM4 can share the third intersecting area 4003.

Switches, S1 to S3, can be provided in each of the first to third intersecting areas, 4001 through 4003. The S1 to S3 can determine whether a current is cut off in the intersecting areas, 4001 through 4003.

The S1 is disposed in the first intersecting area 4001 and can block a current in the first intersecting area 4001. The S1 can be turned on or off, and when S1 is turned on, current flows in the first intersecting area 4001. When S1 is turned off, current may not flow in the first intersecting area 4001.

The S2 can be disposed in the second intersecting area 4002 and block a current in the second intersecting area 4002. The S2 can be turned on or off. When S2 is turned on, current flows in the second intersecting area 4002. When S2 is turned off, current may not flow in the second intersecting area 4002.

The S3 can be disposed in the third intersecting area 4003 and block a current in the third intersecting area 4003. The S3 can be turned on or off. When S3 is turned on, current flows in the third intersecting area 4003. When S3 is turned off, current may not flow in the third intersecting area 4003.

That is, the area of the closed loop formed in IM can vary depending on whether S1 to S3 are turned on or off. Thus, heating amount of IM can be adjusted.

Also, a non-intersecting area (e.g., a switch can be further disposed in an area 4004 of the IM4).

On the other hand, in FIGS. 5 to 11, the heating areas, IM1 to IM4, formed on IM can have a closed loop larger than the outer diameter of single WC or the sum of two or more WCs.

That is, the area of the closed loop formed in the heating areas, IM1 to IM4, formed on IM can be smaller than the outer diameter of single WC or the sum of two or more WCs.

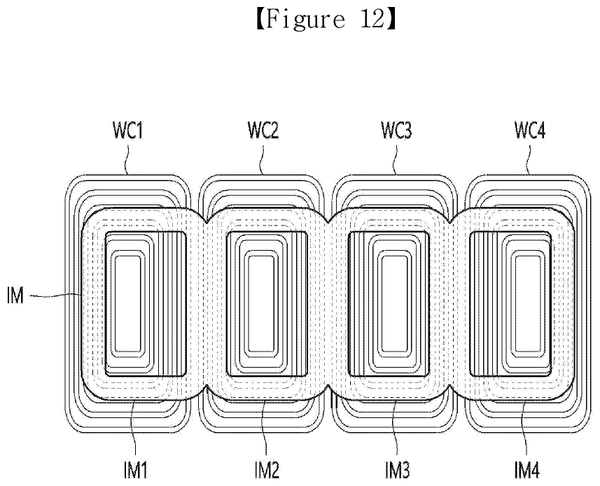

FIG. 12 is a plan view illustrating a WC and an IM according to a seventh embodiment of the present disclosure.

As shown in FIG. 12, IM has a plurality of heating areas, IM1 to IM3, corresponding to a plurality of WCs, WC1 to WC4, respectively. Each of the plurality of heating areas, IM1 to IM4, can have a smaller outer diameter than each of the plurality of WCs, WC1 to WC4.

Accordingly, according to the position and size of the HO, at least one of WCs, WC1 to WC4, operates. Similarly, at least some of IMs, IM1 to IM4, can generate heat according to the position and size of HO. For example, when HO is placed at a position corresponding to IM2, WC2 can operate to generate a magnetic field, and the magnetic field generates a magnetic field. The IM2 can generate heat. However, this is an example, and one WC or two or more WCs can operate according to the size of HO, and WCs operating can vary depending on the position of HO.

FIG. 13 is a plan view illustrating a WC and an IM according to an eighth embodiment of the present disclosure.

As shown in FIG. 13, in IM, a plurality of heating areas, IM1 to IM3, which are corresponded to two WCs among the plurality of WCs, WC1 to WC4, can be formed. That is, IM1 corresponds to WC1 and WC2, and IM2 corresponds to the WC2 and WC3. And IM3 can correspond to the WC3 and WC4. The IM1 can be smaller than the outer diameter of the sum of WC1 and WC2. The IM2 can be smaller than the outer diameter of the sum of WC2 and WC3. The IM3 can be smaller than the sum of WC3 and WC4.

Accordingly, according to the position and size of HO, at least one of WC1 to WC4 operates. Similarly, at least some of IM1 to IM3 can generate heat according to the position and size of HO. For example, when HO is placed at a position corresponding to IM2, WC2 and WC3 can operate to generate a magnetic field, and this magnetic field heat can be generated in IM2 by passing through IM2. However, this is an example, and one WC or two or more WCs can operate according to the size of HO, and WCs operating can vary depending on the position of HO.

As described with reference to FIGS. 12 and 13, the shape and size of IM can be independent of the outer diameter of the WC.

In summary, IM is coupled with at least one WC through a magnetic field, and it can be sufficient for WCs to have IM coupled to achieve a shape and size capable of generating output.

However, it should be noted that in the aforementioned examples, IM was described as being formed by a single component, but this is merely illustrative. According to the embodiments, IM can also be formed by multiple heating elements.

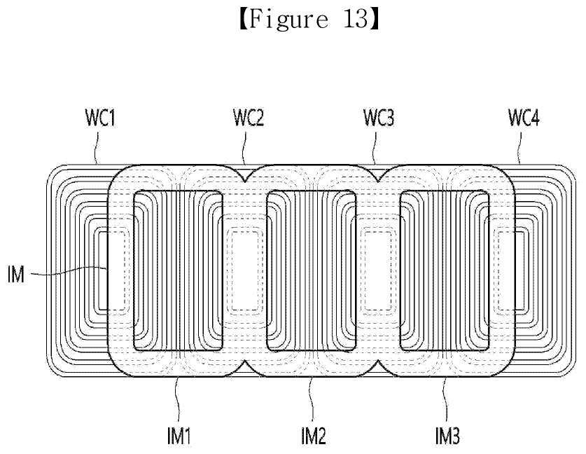

FIG. 14 is an illustrative diagram showing the appearance of an intermediate heating element formed by multiple heating elements according to an exemplary embodiment of the present disclosure.

The IM can be composed of heating regions, IM1 to IM4, in which each of the heating areas, IM1 to IM4, can be formed by multiple heating elements.

At least one of the multiple heating elements, IM13, IM23, IM33, and IM44 has a shape with a closed loop larger than the outer diameter of at least one of the multiple working coils, while at least one of the other heating elements, IM11, IM12, IM21, IM22, IM31, IM32, IM41, and IM42, can have a shape with a closed loop smaller than the outer diameter of at least one of the multiple WCs.

The IM1 can be formed by the first to third heating elements, IM11 to IM13. The IM2 can be formed by the fourth to sixth heating elements, IM21 to IM23. The IM3 can be formed by the seventh to ninth heating elements, IM31 to IM33. The IM4 can be formed by the tenth to twelfth heating elements, IM41 to IM43. The IM13 and IM23 can share the first intersection region 4001, IM23 and IM33 can share the second intersection region 4002, and IM33 and IM43 can share the third intersection region 4003.

Meanwhile, according to another embodiment of the present disclosure, as in the example of FIG. 14, a switch can be provided in IM formed of a plurality of members.

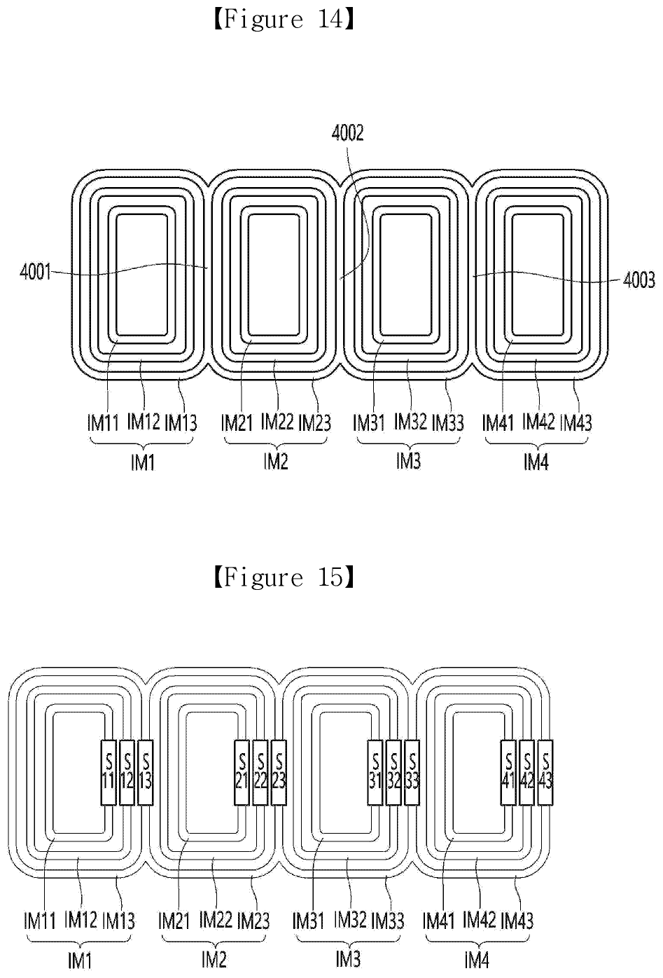

FIG. 15 is an exemplary view illustrating arrangement of an IM and a switch formed of a plurality of heating members according to an embodiment of the present disclosure.

As described in FIG. 14, IM is composed of the first to fourth heating areas, IM1 to IM4, and IM1 to IM4 can be formed of a plurality of heating elements.

The IM1 can be formed of the first to third heating members IM11 to IM13, and the IM2 can be formed of the fourth to sixth heating members, IM21 to IM23, the IM3 can be formed of the seventh to ninth heating members IM31 to IM33, and the IM4 can be formed of the tenth to twelfth heating members IM41 to IM43. The IM13 and IM23 can share the first intersecting area 4001, and IM23 and IM33 can share the second intersecting area 4002. The IM33 and IM43 can share the third intersecting area 4003.

The cooking appliance can include switches, S11 to S13, S21 to S23, S31 to S33 and S41 to S43 that determines whether a closed loop is formed in each of a plurality of heating members.

Specifically, the cooking appliance can include a first switch S11 for determining whether to form a closed loop in IM11, a second switch S12 for determining whether to form a closed loop in IM12, a third switch S13 for determining whether to form a closed loop in IM13, a fourth switch S21 for determining whether to form a closed loop in IM21, a fifth switch S22 for determining whether to form a closed loop in IM22, a sixth switch S23 for determining whether to form a closed loop in IM23, and whether or not a closed loop is formed in IM31. The seventh switch S31 can determine whether a closed loop is formed in IM32, the eighth switch S32 can determine whether a closed loop is formed in the ninth heating member IM33, and the ninth switch determines whether a closed loop is formed in IM33. The tenth switch S41 for determining whether to form a closed loop in IM41, the eleventh switch S42 for determining whether to form a closed loop in IM42, a twelfth switch S43 for determining whether to form a closed loop in IM43 can be further included.

In addition, S13 can determine whether to block the current in the first intersecting area 4001, S23 can determine whether to block the current in the second intersecting area 4002, and S33 can determine whether or not to block the current in the third intersecting area 4003.

The S43 can determine whether to block the formation of a closed loop in IM.

Meanwhile, according to an embodiment, among the switches shown in FIG. 15, S11 and S12, S21 and S22, S31 and S32, and S41, S42, and S43 can be omitted. That is, switches can be installed only in the intersecting areas 4001 to 4003.

Meanwhile, in the above-described embodiments, IM has been described as having a rectangular shape, but this is merely an example. The IM can have a different shape depending on WC.

Depending on the embodiment, WC and IM can be formed in a concentric circle shape. The IM can be formed in a shape having a closed loop larger than the outer diameter of WC.

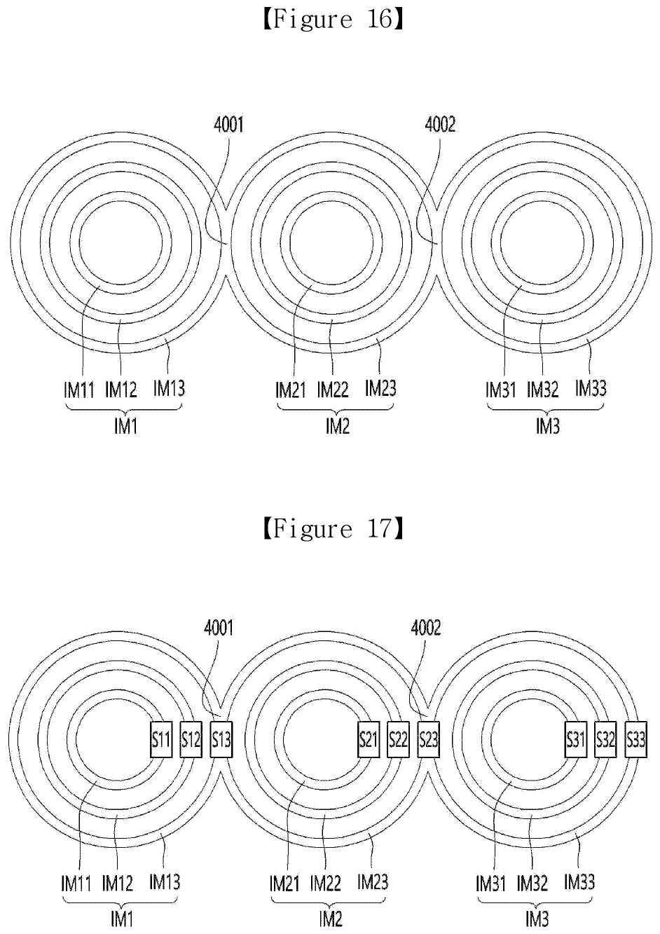

FIG. 16 is an exemplary view showing a state in which an IM is formed in a plurality of concentric circle shapes according to an embodiment of the present disclosure.

The IM is composed of IMs, IM1 to IM3, and each of IM1 to IM3 includes a plurality of heating elements.

The IM1 can be formed of IM11, IM12, and IM13. The IM2 can include IM21 to IM23. The IM3 can be formed of IM31 to IM33. The IM13 and IM23 can share the first intersecting area 4001. The IM23 and IM33 can share the second intersecting area 4002.

On the other hand, according to another embodiment of the present disclosure, as in the example of FIG. 16, a switch can be provided in IM formed in a concentric circle shape.

FIG. 17 is an exemplary diagram illustrating the arrangement of IMs and switches formed in a plurality of concentric circle shapes according to an embodiment of the present disclosure.

As described in FIG. 16, IM can be composed of IM1 to IM3, and each of IM1 to IM3 can be formed of a plurality of heating elements.

The IM1 can be formed of IM11, IM12, and IM13. The IM2 can be formed of IM21, IM22, IM23. The IM3 can be formed of IM31, IM32, and IM33. The IM13 and IM23 can share the first intersecting area 4001. The IM23 and IM33 can share the second intersecting area 4002.

At this time, the cooking appliance can include a first switch S11 for determining whether to form a closed loop in IM11, a second switch S12 for determining whether to form a closed loop in IM12, a third switch S13 for determining whether to form a closed loop in IM13, a fourth switch S21 for determining whether to form a closed loop in IM21, a fifth switch S22 for determining whether to form a closed loop in IM22, a sixth switch S23 for determining whether to form a closed loop in IM23, and a seventh switch 31 for determining whether to form a closed loop in IM31, an eighth switch S32 for determining whether to form a closed loop in IM32, and the ninth switch S33 for determining whether to form a closed loop in IM33.

In addition, S13 can determine whether to block the current in the first crossover region 4001, and S23 can determine whether to block the current in the second crossover region 4002.

Meanwhile, according to an embodiment, among the switches shown in FIG. 15, S11 and S12, S21 and S22, and S31 and S32 can be omitted. That is, switches can be installed only in the intersecting areas 4001 and 4002.

Depending on the embodiment, even if WC has a concentric circle shape, IM may not have a concentric circle shape. The IM can be formed in a shape having an elliptical closed loop and a circular closed loop.

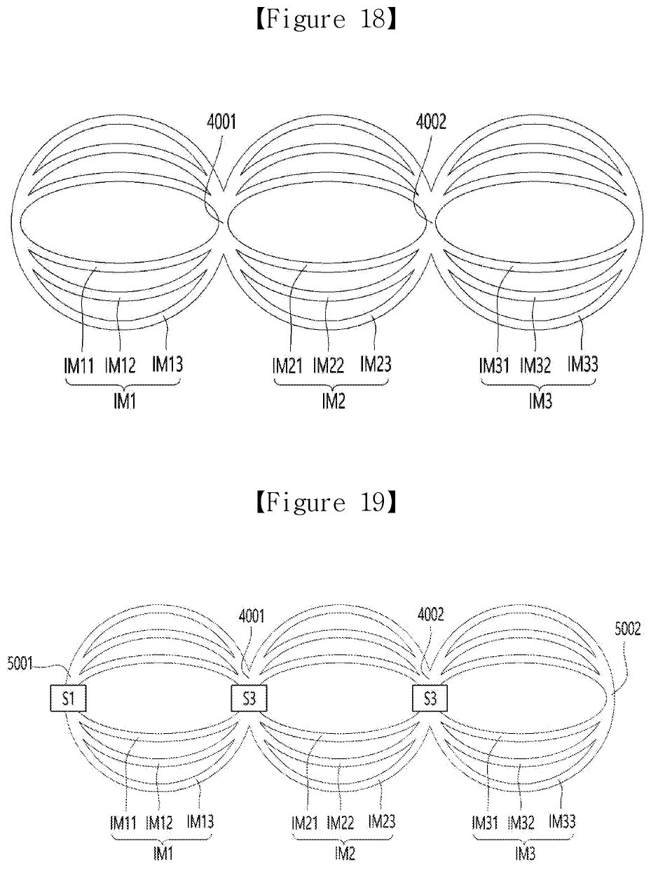

FIG. 18 is an exemplary view showing an IM formed in a shape having an elliptical closed loop and a circular closed loop according to an embodiment of the present disclosure.

The IM can be composed of IM1 to IM3. The IM1 can include an elliptical closed loop part, IM11 and IM12. The IM2 can include the parts IM21 and IM22 having an elliptical closed loop and the part IM23 having a circular closed loop. The IM3 can be formed of parts IM31 and IM32 having an elliptical closed loop and a part IM33 having a circular closed loop.

The IM1 and IM2 can share a first intersecting area 4001, and IM2 and IM3 can share a second intersecting area 4002.

Meanwhile, according to another embodiment of the present disclosure, a switch can be provided in IM having a closed loop having various shapes as in the example of FIG. 18.

FIG. 19 is an exemplary view illustrating arrangement of IMs and switches having closed loops of various shapes according to an embodiment of the present disclosure.

As described in FIG. 18, IM can be composed of IM1 to IM3. The IM1 can include an elliptical closed loop IM11 and IM12 and a portion having a circular closed loop IM3. The IM2 can include a portion IM21 and IM22 having an elliptical closed loop and a circular closed loop. The IM3 can be formed of an elliptical closed loop portion IM31 and IM32 and a circular closed loop portion IM33.

The IM1 and IM2 can share a first intersecting area 4001. The IM2 and IM3 can share a second intersecting area 4002.

In this situation, the cooking appliance can further include S1 disposed in the first intersecting area 4001 and S2 disposed in the second intersecting area 4002.

In addition, S3 disposed in at least one of IM1 excluding the first intersecting area 4001 and the third heating area IM3 excluding the second intersecting area 4002 is further included.

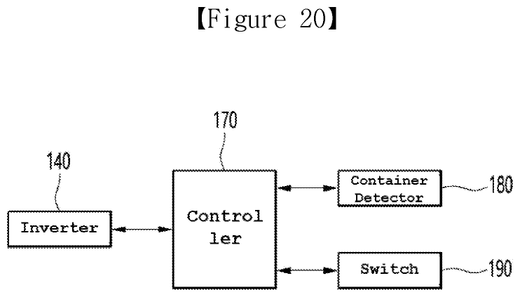

FIG. 20 is a control block diagram for explaining a method of operating a cooking appliance according to an embodiment of the present disclosure.

A cooking appliance according to an embodiment of the present disclosure can include an inverter 140, a controller 170, a container detector 180, and a switch unit 190. Meanwhile, the components shown in FIG. 20 show only components necessary to explain the operation of the cooking appliance, and other components can be further included.

Since the inverter 140 is the same as that described in FIG. 2, redundant descriptions will be omitted.

The controller 170 can control the inverter 140, the vessel detection unit 180 and the switch unit 190.

The container detector 180 can detect HO placed on the upper plate 15. The container sensor 180 can obtain at least one of a position where HO is placed, a size and a material of HO.

The switch unit 190 can include the aforementioned switches.

The controller 170 controls the inverter 140 to operate a specific working coil according to the location, size, and material of HO detected by the container detector 180, and the IM can be possible to control the switch unit 190 so that the amount of heat generated is controlled.

For example, the controller 170 can drive WCs at positions overlapping with HO in a vertical direction based on the position and size of HO.

Also, the controller 170 can control the phases of the plurality of WCs according to the material of the HO. For example, if HO is a magnetic material, the controller 170 can control the driven WCs in opposite phases. Accordingly, it is possible to reduce the magnetic field coupled to IM when it is a magnetic material.

If HO is a magnetic material, the controller 170 can turn off at least one switch (e.g., a switch positioned vertically overlapping the HO). The controller 170 can turn off all switches when HO is a magnetic material.

The controller 170 can control all switches to be turned on when HO is a non-magnetic material.

The above description is merely an example of the technical idea of the present disclosure, and various modifications and variations can be made to those skilled in the art without departing from the essential characteristics of the present disclosure.

Therefore, the embodiments disclosed in this disclosure are not intended to limit the technical spirit of the present disclosure, but to explain, and the scope of the technical spirit of the present disclosure is not limited by these embodiments.

The protection scope of the present disclosure should be construed by the claims below, and all technical ideas within the scope equivalent thereto should be construed as being included in the scope of the present disclosure.

What is claimed is:

1. A cooking appliance comprising:
a top plate portion configured to support an object to be heated;
an intermediate heating body configured to transfer heat to the object; and
a plurality of working coils configured to generate a magnetic field to heat at least a portion of the object and the intermediate heating body,
wherein the intermediate heating body includes one or more heating areas corresponding to one or more working coils among the plurality of working coils.

2. The cooking appliance according to claim 1, wherein each of the one or more heating areas of the intermediate heating body corresponds to one working coil among the plurality of working coils.

3. The cooking appliance according to claim 1, wherein each heating area among the one or more heating areas corresponds to two adjacent working coils among the plurality of working coils, and
wherein an outer diameter of the two adjacent working coils is larger than an inner diameter of each heating area among the one or more heating areas and smaller than an outer diameter of each heating area among the one or more heating areas.

4. The cooking appliance according to claim 1, wherein the one or more heating areas include at least two heating areas, and
wherein the intermediate heating body includes an intersection region between the at least two heating areas.

5. The cooking appliance according to claim 4, further comprising at least one switch configured to block current from flowing in the intersection region.

6. The cooking appliance according to claim 5, wherein the switch is configured to be turned on or off based on a type of the object to be heated.

7. The cooking appliance according to claim 6, wherein the switch is configured to be turned off to block current from flowing in the intersection region when the object to be heated is a magnetic body, and turned on to allow current to flow in the intersection region when the object to be heated is a non-magnetic body.

8. The cooking appliance according to claim 6, wherein phases of the plurality of working coils are controlled differently based on the type of the object to be heated.

9. The cooking appliance according to claim 8, wherein the plurality of working coils are configured to operate with opposite phases when the object to be heated is the magnetic body.

10. The cooking appliance according to claim 1, wherein the intermediate heating body includes a plurality of heating elements, and
wherein at least one of the plurality of heating elements has a closed loop shape that is larger than an outer diameter of one or more working coils among the plurality of working coils.

11. The cooking appliance according to claim 10, further comprising a switch configured to open or disconnect the closed loop shape of the at least one of the plurality of heating elements.

12. The cooking appliance according to claim 1, wherein the intermediate heating body includes a plurality of heating elements, and
wherein at least one of the plurality of heating elements has a closed loop shape that is smaller than an outer diameter of one or more working coils.

13. A cooking appliance comprising:
at least one working coil configured to generate a magnetic field to heat an object placed on the cooking appliance; and
an intermediate heating body overlapping with at least a portion of the at least one working coil and configured to generate heat based on the magnetic field and transfer the heat to the object.

14. The cooking appliance according to claim 13, further comprising:
a switch connected between two portions of the intermediate heating body, the switch being configured to:
in response to being opened, disconnect the two portions of the intermediate heating body from each other, and
in response to being closed, connect the two portions of the intermediate heating body to form a closed loop shape.

15. The cooking appliance according to claim 14, wherein an outer diameter of the closed loop shape of the intermediate heating body is larger than an outer diameter of the at least one working coil, and
wherein an inner diameter of the closed loop shape of the intermediate heating body is smaller than the outer diameter of the at least one working coil.

16. The cooking appliance according to claim 14, wherein both of an outer diameter of the closed loop shape of the intermediate heating body and an inner diameter of the closed loop shape of the intermediate heating body are smaller than an outer diameter of the at least one working coil.

17. The cooking appliance according to claim 14, wherein an outer diameter of the closed loop shape of the intermediate heating body is equal to an outer diameter of the at least one working coil.

18. The cooking appliance according to claim 14, wherein the at least one working coil includes two adjacent working coils, and
wherein the closed loop shape of the intermediate heating body overlaps with both of the two adjacent working coils.

19. The cooking appliance according to claim 13, further comprising:
a switch connected between two portions of the intermediate heating body, the switch being configured to:
in response to the object being a magnetic object, disconnect the two portions of the intermediate heating body from each other, and
in response to the object being a non-magnetic material, connect the two portions of the intermediate heating body to form a closed loop shape.

20. The cooking appliance according to claim 13, wherein the intermediate heating body includes two heating areas, the two heating areas being connected to each other at an intersection region, and
wherein the switch is located at the intersection region.
